(19) United States
(12) Patent Application Publication
(10) Pub. No.: US 2026/0115073 A1
(43) Pub. Date: Apr. 30, 2026

(54) AUTONOMOUS MOBILE ROBOT FOR IN-HOSPITAL PATIENT TRANSPORT, INCLUDING STRETCHERS, HOSPITAL BEDS, COTS, PATIENT CARTS, AND GURNEYS

(71) Applicant: Rovex Technologies Corporation, Gainesville, FL (US)

(72) Inventors: David CRABB, Gainesville, FL (US); Axton ISALY, Gainesville, FL (US)

(21) Appl. No.: 19/082,997

(22) Filed: Mar. 18, 2025

Related U.S. Application Data
(60) Provisional application No. 63/712,032, filed on Oct. 25, 2024.
(60) Provisional application No. 63/770,068, filed on Mar. 11, 2025.

(51) Int. Cl. A61G 7/08; A61G 3/08; A61G 7/05

(52) U.S. Cl. CPC A61G 7/08; A61G 3/0833; A61G 3/0866; A61G 7/0528; A61G 2203/22

(57) ABSTRACT

An autonomous robotic system and methods for transporting patient stretchers, hospital beds, gurneys, and other patient transport apparatuses are provided. The autonomous robotic system includes a mobile robot module including extendable arms configured to interface with wheels of patient apparatuses; a wheel engagement module configured for capturing, lifting, guiding, caging, steering, or pulling the wheels of the patient apparatuses; and a navigation module including LiDAR, computer vision, and/or other sensors to autonomously guide the mobile robot module within hospital environments.

### CROSS-REFERENCE TO RELATED APPLICATIONS

The present application claims the benefit of U.S. Provisional Application Ser. No. 63/770,068, filed Mar. 11, 2025, and 63/712,032, filed Oct. 25, 2024, each of which is hereby incorporated by reference herein in its entirety, including any figures, tables, or drawings.

### BACKGROUND OF THE INVENTION

Patient transport within hospitals is a significant operational challenge, especially in high-demand areas such as the Emergency Department (ED). The current reliance on human labor to transport patients on stretchers, hospital beds, cots, patient carts, and gurneys results in frequent delays, inefficient workflows, injuries to workers, and the diversion of healthcare staff from direct patient care.

### SUMMARY OF THE INVENTION

There continues to be a need in the art for improved designs and techniques for autonomous mobile robot system for in-hospital patient transport.

According to an embodiment of the subject invention, an autonomous robotic system for transporting patient stretchers, hospital beds, gurneys, and other patient transport apparatuses is provided. The autonomous robotic system comprises a mobile robot comprising extendable arms configured to interface with wheels of patient apparatuses; a wheel engagement module configured for capturing, lifting, guiding, pulling, and/or caging the wheels of the patient apparatuses; a navigation module comprising LiDAR, computer vision, laser sensors, ultrasonic sensors, infrared sensors, radar sensors, inertial measurement, tactile sensors and/or other sensors to autonomously guide the mobile robot within hospital environments.

In another embodiment, a method for transporting patient apparatuses, including stretchers, hospital beds, gurneys, and other patient transport apparatuses is provided. The method comprises engaging, lifting, guiding, pulling, and/or caging, by a robot, wheels of the patient apparatuses for autonomous movement.

In certain embodiment, a system comprising two autonomous robots configured to collaborate to engage, lift, guide, pull, and/or cage both sets of wheels of a patient apparatus, allowing an entire stretcher, bed, or gurney to be elevated off the ground or guided for transport is provided.

### BRIEF DESCRIPTION OF THE DRAWINGS

FIG. 1 shows the Autonomous Mobile Robot (AMR) system having a platform on the front that hosts the sensors, batteries, on-board computer, or other necessary devices, wherein the wheel engagement module is open to accept the patient transport apparatus wheel, according to an embodiment of the subject invention.

FIG. 2 is a closer view of the extendable arm module for adjusting to different stretcher widths, according to an embodiment of the subject invention.

FIG. 3 is a closer view of the rear gate module showing the hinge, motor, and lever arm, according to an embodiment of the subject invention.

FIG. 4 is another closer view of the rear gate module showing the rod, contact plate, and the latch, according to an embodiment of the subject invention.

FIG. 5 is a closer view of the front lifting rod, showing the lifting block, guide bushings, and geared lead screw actuation assembly, according to an embodiment of the subject invention.

FIG. 6 is another embodiment of the wheel engagement module that guides the stretcher wheel through a passive module, according to an embodiment of the subject invention.

FIG. 7 is another view of the AMR system, according to an embodiment of the subject invention.

FIG. 8 shows the AMR system interfacing with a patient stretcher, according to an embodiment of the subject invention.

FIG. 9 shows a dedicated view of the wheel engagement module with the rear gate module closed, according to an embodiment of the subject invention.

### DETAILED DESCRIPTION OF THE INVENTION

The embodiments of subject invention pertain to an autonomous robotic system.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The embodiments of the subject invention address aforementioned inefficiencies by providing an autonomous robotic system configured to transport various apparatuses, such as stretchers, hospital beds, cots, patient carts, and gurneys, thereby optimizing hospital logistics and improving overall patient care.

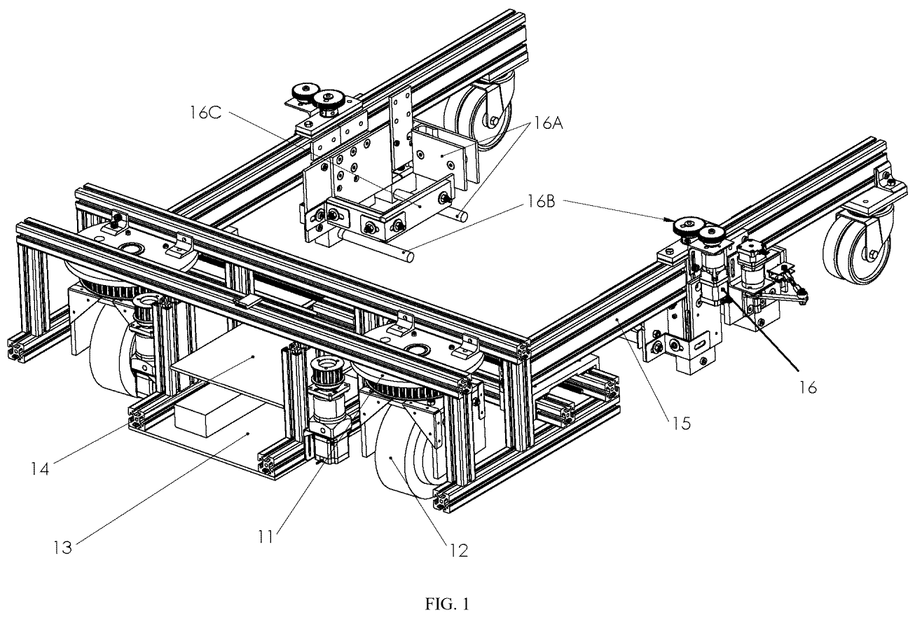

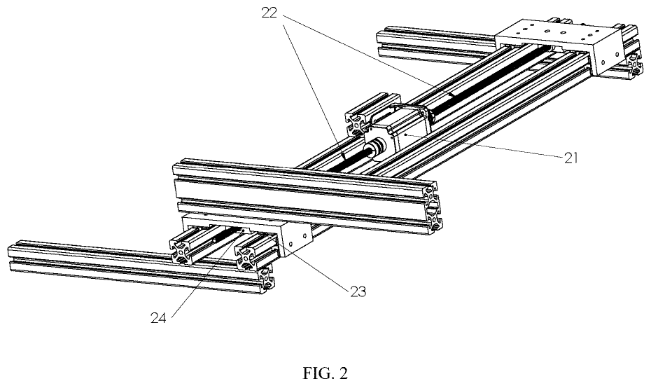

FIG. 1 shows an autonomous mobile robot system comprising a steering assembly 11 that is a spinning platform and a drive motor 12 that may propel the robot in various directions. Moreover, the system comprises a battery compartment 13 and an electronics compartment 14 for holding electrical and computer components for autonomous actions. The autonomous mobile robot system further comprises extendable arms 15 that can be adjusted according to the width of the wheelbases of these apparatuses. Further, a wheel engagement module 16 is configured to engage with the wheels of the stretcher to cage, grasp, guide, and/or lift the wheels. The wheel engagement module 16 may comprise a rear gate 16A which rotates to capture the wheel once in position, and a front lifting device 16B which may lift the wheel to complete engagement. In addition, a capture cage 16C is configured to align the stretcher wheel during engagement for proper fit. FIG. 2 shows a detailed view of the extendable arms 15. A motor 21 is configured to drive a pair of opposite hand threaded lead screws 22 and the lead screws allow for the translation of the arms mount 23 through engagement with a lead screw nut 24.

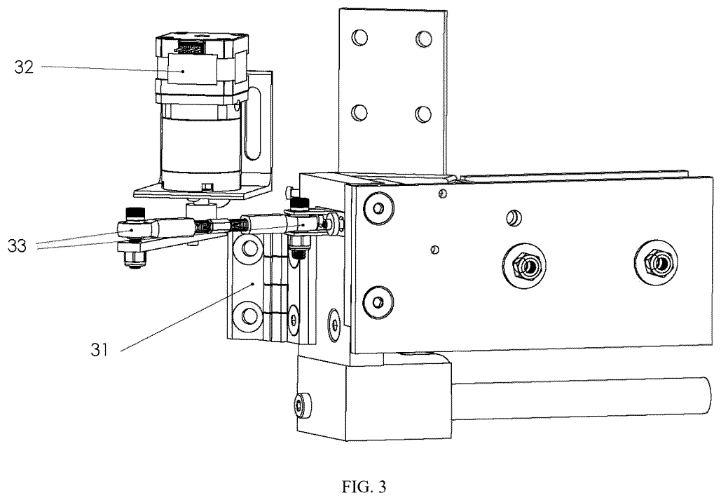

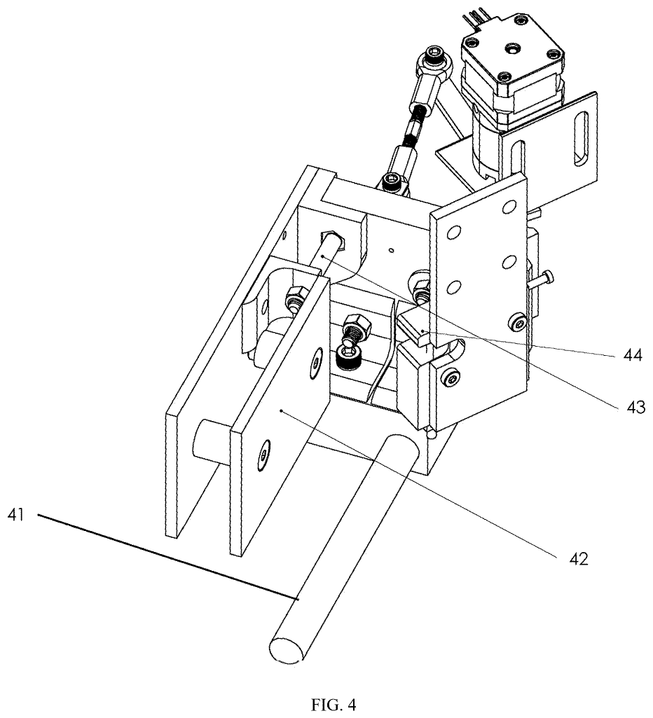

FIG. 3 and FIG. 4 show detailed views of the rear gate 16A. The gate comprises an assembly mounted to a hinge 31. The assembly is actuated with a motor 32 that rotates the assembly about the hinge using a lever arm 33. The assembly comprises a rod 41 and a contact plate 42 that ensures the wheel does not roll out of the capture cage. The assembly is secured into its final position when a pin 43 on the assembly locks into an electronic latch 44.

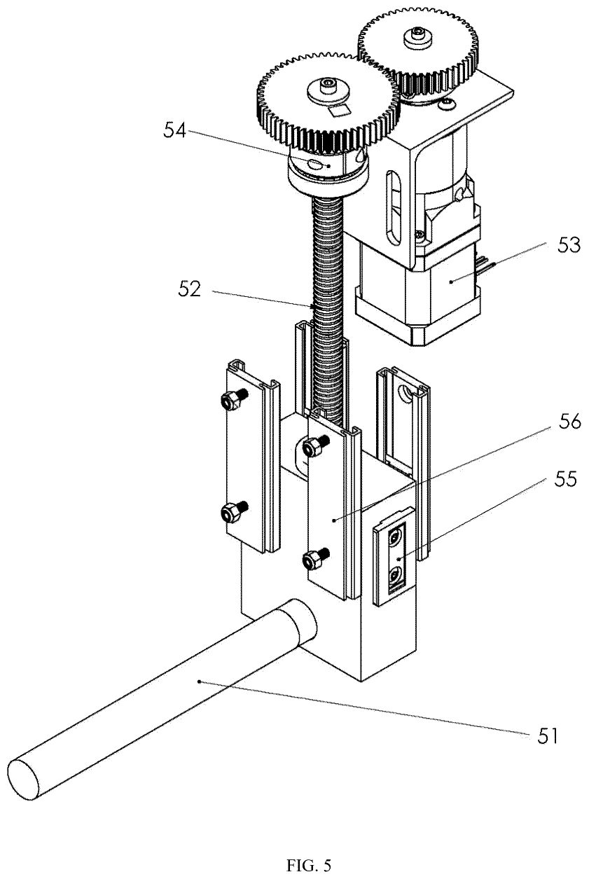

Further, FIG. 5 shows the front lifting rod mechanism 16B which comprises a front lifting rod 51 that is actuated via lead screw 52, which is actuated by a motor 53 via a geared assembly 54 The front lifting block 55 is guided by a set of linear bushings 56 mounted to the frame of the extendable arms.

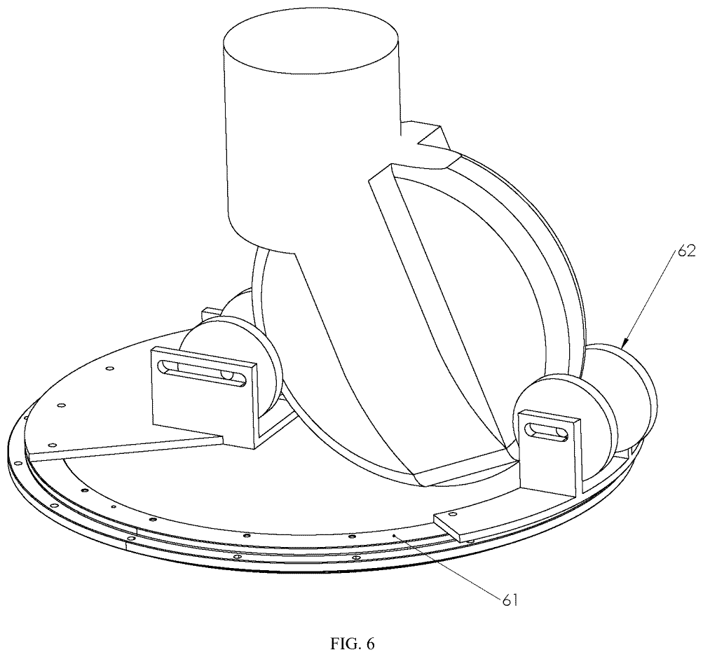

Another embodiment of the wheel engagement module is any suitable module that enables the stretcher wheels to roll freely along the ground while pivoting about its steering axis. The module may be either powered or passive. In the powered embodiment, the wheel is driven to roll and steer through motorized guidance. In the passive embodiment, the wheel moves freely, allowing for regular motions. One embodiment of a passive embodiment is shown in FIG. 6. The module comprises a curved guide bearing 61 which allows the stretcher wheel to pivot about its steering axis, and a set of rollers 62 that allow the stretcher wheels to roll freely. The curved rollers constrain the wheel, inhibiting it from turning out of the grip of the module, ensuring that the rollers turn with the stretcher wheel.

The autonomous mobile robot system also includes advanced sensors, such as LiDAR, computer vision, laser sensors, ultrasonic sensors, infrared sensors, radar sensors, inertial measurement, tactile sensors, GPS and/or other navigation devices, to autonomously navigate hospital environments, avoiding obstacles and following dynamically generated routes. Furthermore, two autonomous mobile robot systems may be configured to operate together to lift or guide both sets of wheels of a stretcher or hospital bed, allowing for the entire apparatus to be lifted off the floor or guided in any direction, providing an additional transport option. In another embodiment, a centralized task management method for autonomous mobile robot navigation is provided. The method can be configured to coordinate a plurality of autonomous mobile robot systems, assigning transport tasks and monitoring operational status, such as needs for charging.

According to the embodiments of the subject invention, the autonomous mobile robot system comprises a drive module, a plurality of extendable arms, a wheel engagement module, and a lifting module.

The drive module includes electric motors that control a set of wheels or tracks, enabling smooth and precise movement in locations such as hospital corridors. Accordingly, the autonomous mobile robot can move at controlled speeds, ensuring safety and comfort for patients during transport.

The plurality of extendable arms may include, for example, two extendable arms, that can be adjusted to the width of various patient transport devices, including but not limited to, stretchers, hospital beds, cots, patient carts, and gurneys. The plurality of extendable arms can accommodate different apparatus and wheel sizes, ensuring compatibility across the hospital's fleet. Moreover, the plurality of extendable arms may be equipped with a locking module to secure them in place during operations.

The wheel engagement module is configured to interact with the wheels of external apparatuses such as stretchers, hospital beds, gurneys, cots, and patient carts. The wheel engagement module may open to capture the wheels and allow them to rotate into place as the autonomous mobile robot system moves into different positions. Once the wheels are engaged, the wheel engagement module closes around them, securing the wheels into place. The wheel engagement module can then lift the wheels slightly off the ground, allowing the autonomous mobile robot system to transport the external apparatus smoothly.

When two sets of wheels (front and back) of a stretcher or bed need to be lifted, two or more the autonomous mobile robot systems may operate in tandem. Each autonomous mobile robot system may engage one set of wheels, and when the two or more the autonomous mobile robot systems operate together, they can lift the entire stretcher or bed off the ground, allowing full transport of patient apparatuses, independent of ground contact.

The lifting module can be configured to elevate the wheels of the stretcher or bed once they are captured, allowing the autonomous mobile robot system to fully bear the weight of the apparatus and its occupant during transport. The lifting module ensures smooth lifting and lowering, reducing any potential for sudden movements that could disrupt patient comfort.

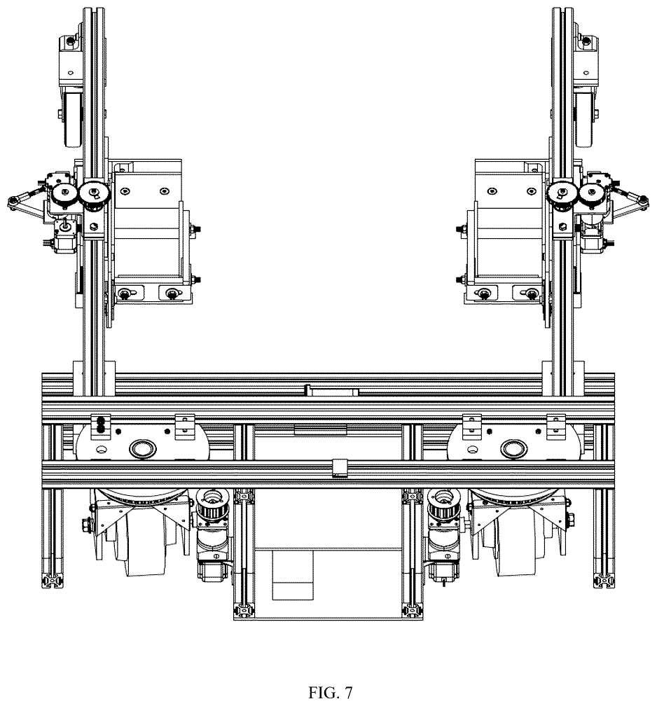

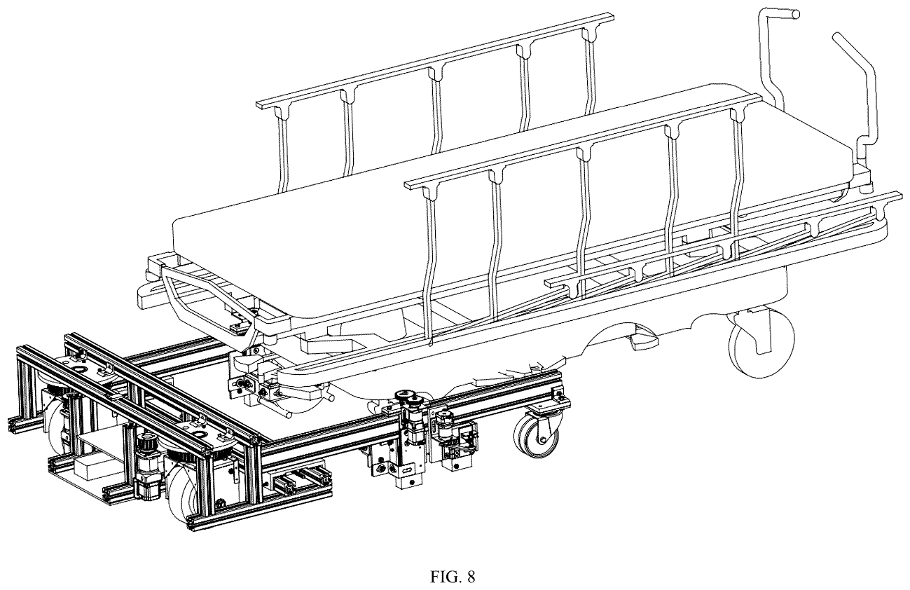

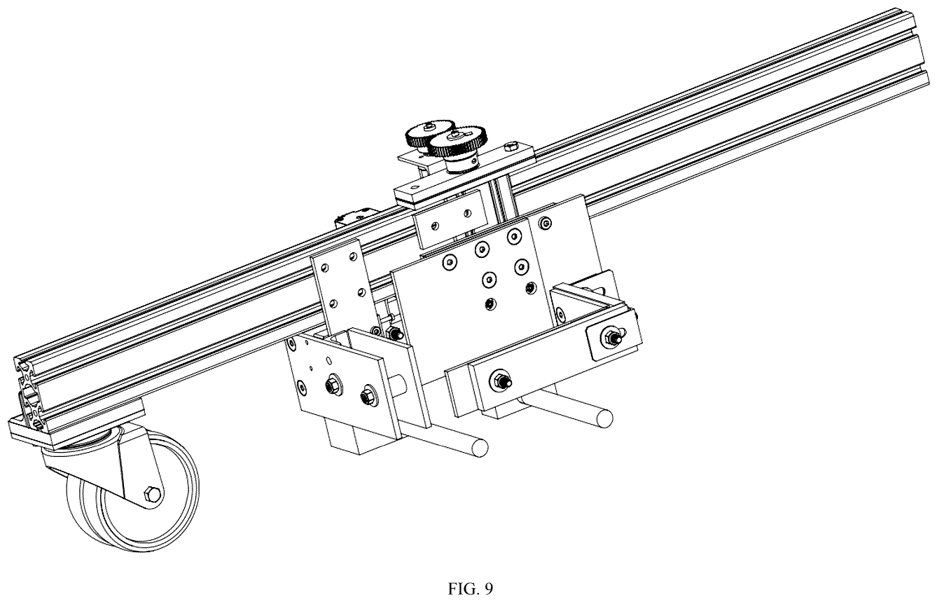

FIG. 7 is another view of the AMR system and FIG. 8 shows the AMR system interfacing with a patient stretcher. In addition, FIG. 9 shows a dedicated view of the wheel engagement module with the rear gate module closed.

### Autonomous Navigation:

The autonomous mobile robot system may use an advanced sensor or combination of them to autonomously navigate hospital environments.

In one embodiment, LiDAR (Light Detection and Ranging) creates a detailed map of the surroundings of the autonomous mobile robot system, allowing it to detect obstacles, avoid collisions, and dynamically adjust its route.

In one embodiment, computer vision may be used to interpret visual information from the surroundings of the autonomous mobile robot system, helping it recognize pathways, doors, and relevant landmarks.

In one embodiment, the autonomous mobile robot system can also integrate ultrasonic, infrared sensors, radar sensors, inertial measurement, tactile sensor, or GPS to enhance its environmental perception in complex hospital layouts.

The navigation system may work in conjunction with hospital floor plans to plot optimal routes, ensuring that patient transport is both efficient and safe.

### System Management Platform:

In one embodiment, the autonomous mobile robot system is coordinated by a centralized management platform that allows hospital staff to monitor and control the operation of multiple robots.

Task Assignment: The platform automatically assigns patient transport tasks to available robots based on real-time demand and priority.

Status Monitoring: The platform tracks each robot's location, task status, and battery levels. It can schedule robots for docking, charging, or having their batteries changed when necessary, ensuring continuous operation.

Multi-Robot Coordination: The system supports multi-robot coordination, where two robots can be assigned to a single transport task to lift and carry both sets of wheels or guide/case both sets of wheels, enabling complete off-the-ground transport or omni-directional motion of stretchers, hospital beds, or gurneys.

This platform offers scalability, allowing hospitals to implement the system with a few robots initially and expand as needed.

Embodiment 1. An autonomous robotic system for transporting a patient apparatus, including stretchers, hospital beds, gurneys, and other patient transport apparatuses, comprising:
a mobile robot module comprising an extendable arm configured to interface with at least one wheel of a patient apparatus;
a wheel engagement module configured for capturing, lifting, guiding, caging, steering, or pulling at least one wheel of the patient apparatus; and
a navigation module comprising LiDAR, computer vision, and/or another sensor to autonomously guide the mobile robot module within a hospital environment.

Embodiment 2. The system of embodiment 1, wherein the robot module comprises a plurality of extendable arms configured to interface with a plurality of wheels, respectively.

Embodiment 3. A method for transporting patient apparatus, including stretchers, hospital beds, gurneys, and other patient transport apparatuses, comprising:
engaging, lifting, guiding, caging, steering, or pulling by an autonomous robotic system, wheels of the patient apparatuses for autonomous movement.

Embodiment 4. The method of embodiment 3, further comprising moving the patient apparatus from one location to another.

Embodiment 5. A system comprising:
two autonomous robotic systems configured to collaborate to lift, guide, cage, steer, or pull two or more wheels of a patient apparatus, allowing an entire stretcher, bed, or gurney to be transported on ground or off ground.

Embodiment 6. An autonomous mobile robot system for in-hospital patient transport apparatus, comprising:
a steering assembly;
a drive motor;
a plurality of extendable arms; and
a wheel engagement module configured to engage with wheels of the transport apparatuses.

Embodiment 7. The system of embodiment 6, further comprising:
a battery compartment; and
an electronics compartment for holding electrical and computer components for autonomous actions.

Embodiment 8. The system of embodiment 6 or 7, wherein the steering assembly is a spinning platform.

Embodiment 9. The system of any of embodiments 6-8, wherein the drive motor is configured to propel the robot system in various directions.

Embodiment 10. The system of any of embodiments 6-9, wherein the plurality of extendable arms are configured to adjust according to widths of wheelbases of the in-hospital patient transport apparatus.

Embodiment 11. The system of any of embodiments 6-10, wherein the wheel engagement module comprises:
a rear gate configured to rotate to capture the wheels once in position;
a front lifting device configured to lift the wheels to complete the engagement; and
a capture cage configured to align the wheels during engagement for proper fit.

Embodiment 12. The system of any of embodiments 6-11, wherein the plurality of extendable arms comprise:
a motor configured to drive a pair of opposite hand threaded lead screws, wherein the lead screws allow for translation of an arms mount through engagement with a lead screw nut.

Embodiment 13. The system of embodiment 11 or 12, wherein the rear gate comprises an assembly mounted to a hinge; wherein the assembly is actuated with a motor that rotates the assembly about the hinge by a lever arm; wherein the assembly comprises a rod and a contact plate that ensures the wheel does not roll out of the capture cage; and wherein the assembly is secured into its final position, when a pin on the assembly locks into an electronic latch.

Embodiment 14. The system of any of embodiments 11-13, wherein the front lifting device comprises:
a front lifting rod that is actuated via a lead screw, which is actuated by a motor via a geared assembly;
a front lifting block guided by a set of linear bushings mounted to frames of the extendable arms.

Embodiment 15. The system of any of embodiments 6-14, wherein the wheel engagement module is configured to enable the wheels to roll freely along ground while pivoting about its steering axis.

Embodiment 16. The system of any of embodiments 6-15, wherein the wheel engagement module is either powered or passive.

Embodiment 17. The system of any of embodiments 6-16, wherein when the wheel engagement module is powered, the wheels are driven to roll and steer through motorized guidance.

Embodiment 18. The system of any of embodiments 6-17, wherein when the wheel engagement module is passive, the wheels move freely, allowing for regular motions.

Embodiment 19. The system of any of embodiments 6-18, wherein the wheel engagement module comprises a curved guide bearing that allows the wheels to a pivot about its steering axis.

Embodiment 20. The system of any of embodiments 6-19, wherein the wheel engagement module comprises a set of rollers that allow the wheels to roll freely.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

I claim:

1. An autonomous robotic system for transporting a patient apparatus, including stretchers, hospital beds, gurneys, and other patient transport apparatuses, comprising:
a mobile robot module comprising an extendable arm configured to interface with at least one wheel of a patient apparatus;
a wheel engagement module configured for capturing, lifting, guiding, caging, steering, or pulling at least one wheel of the patient apparatus; and
a navigation module comprising LiDAR, computer vision, and/or another sensor to autonomously guide the mobile robot module within a hospital environment.

2. The system of claim 1, wherein the robot module comprises a plurality of extendable arms configured to interface with a plurality of wheels, respectively.

3. A method for transporting patient apparatus, including stretchers, hospital beds, gurneys, and other patient transport apparatuses, comprising:
engaging, lifting, guiding, caging, steering, or pulling by an autonomous robotic system, wheels of the patient apparatuses for autonomous movement.

4. The method of claim 3, further comprising moving the patient apparatus from one location to another.

5. A system comprising:
two autonomous robotic systems configured to collaborate to lift, guide, cage, steer, or pull two or more wheels of a patient apparatus, allowing an entire stretcher, bed, or gurney to be transported on ground or off ground.

6. An autonomous mobile robot system for in-hospital patient transport apparatus, comprising:
a steering assembly;
a drive motor;
a plurality of extendable arms; and
a wheel engagement module configured to engage with wheels of the transport apparatuses.

7. The system of claim 6, further comprising:
a battery compartment; and
an electronics compartment for holding electrical and computer components for autonomous actions.

8. The system of claim 6, wherein the steering assembly is a spinning platform.

9. The system of claim 6, wherein the drive motor is configured to propel the robot system in various directions.

10. The system of claim 6, wherein the plurality of extendable arms are configured to adjust according to widths of wheelbases of the in-hospital patient transport apparatus.

11. The system of claim 6, wherein the wheel engagement module comprises:
a rear gate configured to rotate to capture the wheels once in position;
a front lifting device configured to lift the wheels to complete the engagement; and
a capture cage configured to align the wheels during engagement for proper fit.

12. The system of claim 6, wherein the plurality of extendable arms comprise:
a motor configured to drive a pair of opposite hand threaded lead screws, wherein the lead screws allow for translation of an arms mount through engagement with a lead screw nut.

13. The system of claim 11, wherein the rear gate comprises an assembly mounted to a hinge; wherein the assembly is actuated with a motor that rotates the assembly about the hinge by a lever arm; wherein the assembly comprises a rod and a contact plate that ensures the wheel does not roll out of the capture cage; and wherein the assembly is secured into its final position, when a pin on the assembly locks into an electronic latch.

14. The system of claim 11, wherein the front lifting device comprises:
a front lifting rod that is actuated via a lead screw, which is actuated by a motor via a geared assembly;
a front lifting block guided by a set of linear bushings mounted to frames of the extendable arms.

15. The system of claim 11, wherein the wheel engagement module is configured to enable the wheels to roll freely along ground while pivoting about its steering axis.

16. The system of claim 11, wherein the wheel engagement module is either powered or passive.

17. The system of claim 11, wherein when the wheel engagement module is powered, the wheels are driven to roll and steer through motorized guidance.

18. The system of claim 11, wherein when the wheel engagement module is passive, the wheels move freely, allowing for regular motions.

19. The system of claim 15, wherein the wheel engagement module comprises a curved guide bearing configured to allow the wheels to a pivot about its steering axis.

20. The system of claim 19, wherein the wheel engagement module comprises a set of rollers configured to allow the wheels to roll freely.
